(19) United States
(12) Patent Application Publication
(10) Pub. No.: US 2004/0008448 A1
(43) Pub. Date: Jan. 15, 2004

(54) Head arm assembly design for high volume hard disk drive

(76) Inventors: Jeffery L. Wang, Tai Po (HK); Takehiro Kamigama, Kowloon (HK); Chi Hung Yuen, Kowloon (HK); Liu Jun Zhang, Dongguan City (CN)

Correspondence Address: KENYON & KENYON, Suite 600, 333 W. San Carlos Street, San Jose, CA, 95110-2711, US

(21) Appl. No.: 10/358,012

(22) Filed: Feb. 3, 2003

(30) Foreign Application Priority Data
Jul. 10, 2002 (WO) PCT/CN02/00488

(51) Int. Cl. G11B 5/48

(52) U.S. Cl. 360/244.3

(57) ABSTRACT

A system and method for simplifying a head stack assembly by coupling more than one head gimbal assembly to the head arm assembly is disclosed. The head arm assembly can be an aluminum unimount assembly. The head gimbal assemblies can be loadbeam and flexible support assembly design. Each slider can be attached to a flexible printed circuitry assembly to connect the sliders to a hard drive control. The head arm assembly can act as an actuator driving section.

### BACKGROUND INFORMATION

The present invention relates to magnetic hard disk drives. More specifically, the present invention relates to a method of simplifying the structure of the head arm assembly.

In the art today, different methods are utilized to improve recording density of hard disk drives. FIG. 1 provides an illustration of a typical drive arm configured to read from and write to a magnetic hard disk. Typically, an electromagnetic motor drives a voice-coil 102 wrapped around a gimbal assembly 104 coupled to a head arm 106 and mounted on an actuator axis 108, controlling the head arm 106 motion across a magnetic hard disk 110. Because of the inherent tolerance (dynamic play) that exists in the placement of a recording head 112 by a VCM 102 alone, micro-actuators 114 are utilized to ‘fine-tune’ head 112 placement. A VCM 102 is utilized for course adjustment and the micro-actuator then corrects the placement on a much smaller scale to compensate for the VCM 102 controlled arm 106 tolerance. This enables a smaller recordable track width, increasing the ‘tracks per inch’ (TPI) value of the hard drive (increased drive density).

Most modem hard disk drives contain multiple surfaces that need to be read by the slider. Both sides of the disk may contain readable data, and more than one disk may be stacked within a single drive. A current embodiment for a head arm assembly for reading both sides of a hard disk is illustrated in FIG. 2. A first head gimbal assembly (HGA) 202 with a first arm 204, a second HGA 206 with a second arm 208, and an actuator driving section 210 with a voice coil 212 are coupled together on a bearing assembly 214 by a nut 216 and collar 218. The first HGA 202 is coupled to a first slider head 220, and the second HGA 206 is coupled to a second slider head 222. Information is read by only one of the heads at a time, and is serially sent from the hard drive.

The efficiency of the hard drive is decreased as more disks are stacked atop each other, requiring more head arms and slider heads. The increase in the number of arms increases weight, increasing the moment of inertia. Greater power consumption and decreased speed result from the greater moment of inertia. Additionally, the ability of the arms to stop at precise points is hindered. Using lower density material such as aluminum to build the arms and reducing the thickness of the arms can reduce the moment of inertia. However, these methods increase the likelihood that the arms will become damaged or deformed.

What is needed is a way to reduce the moment of inertia in the arms without compromising speed, durability, energy efficiency, or accuracy.

### BRIEF DESCRIPTION OF THE DRAWINGS

FIG. 1 provides an illustration of a drive arm configured to read from and write to a magnetic hard disk as used in the art.

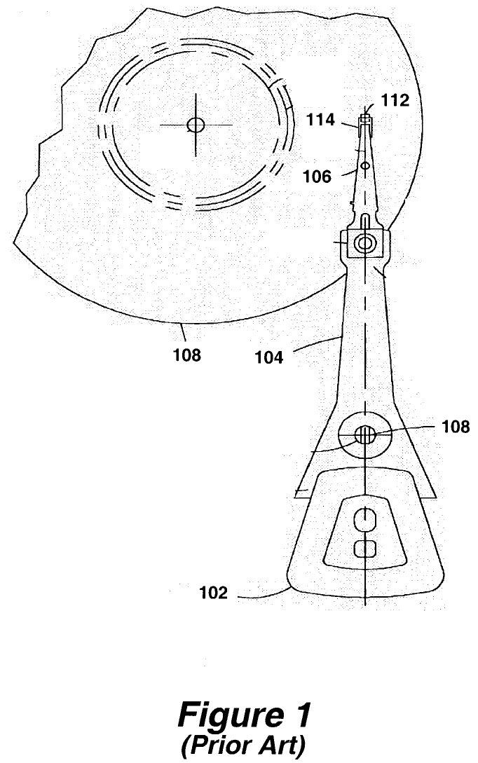

FIG. 2 provides an illustration of a prior art multi-arm assembly.

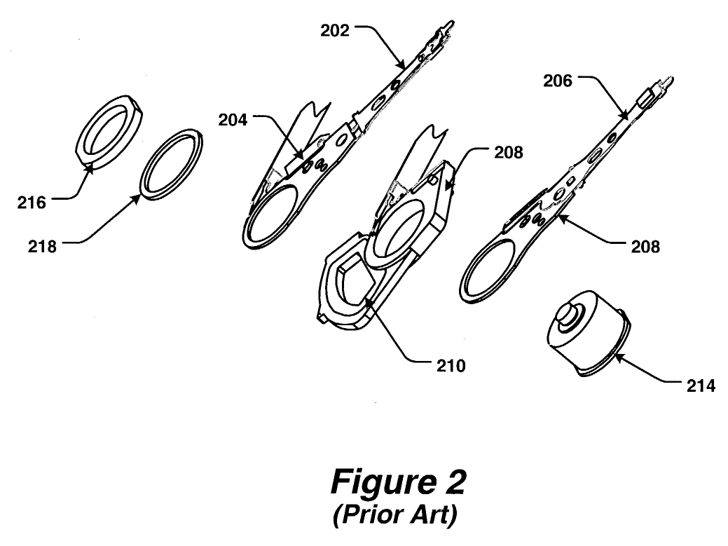

FIG. 3 provides an illustration of a head gimbal assembly arm and loadbeam and flexible support assembly.

FIG. 4 provides an exploded illustration of loadbeam and flexible support assembly.

### DETAILED DESCRIPTION

A system and method for simplifying a head stack assembly by coupling more than one head gimbal assembly to the head arm assembly is disclosed. The head arm assembly may be an aluminum unimount assembly. The head gimbal assemblies may be of a loadbeam and flexible support assembly design. Each slider may be attached to a flexible printed circuitry assembly to connect the sliders to a hard drive control. The head arm assembly may act as an actuator driving section.

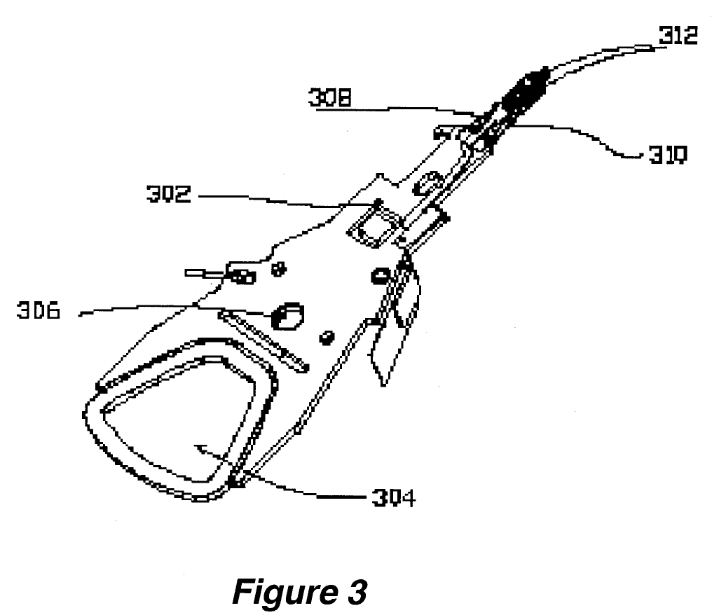

One embodiment of the Head Stack Assembly (HSA) is illustrated in FIG. 3. In one embodiment, the Head Arm Assembly (HAA) 302 has a voice coil 304 at one end, located close to the actuator axis 306. At the other end, a first head gimbal assembly (HGA) 308 and a second HGA 310 are coupled to the HAA 302. In one embodiment, each HGA is a unimount HGA. The first HGA 308 and the second HGA 310 both have a slider head 312 that reads from and writes to the disk. In one embodiment, the slider heads 312 are oriented as to read a disk placed between the first and second HGA. In an alternate embodiment, one or both of the slider heads 312 are to read a disk exterior to the first and second HGA. In one embodiment, more than two HGAs with sliders are coupled to the HAA. In a further embodiment, the head arm assembly is a unimount head arm assembly. The head arm assembly may be made of aluminum or other light weight materials.

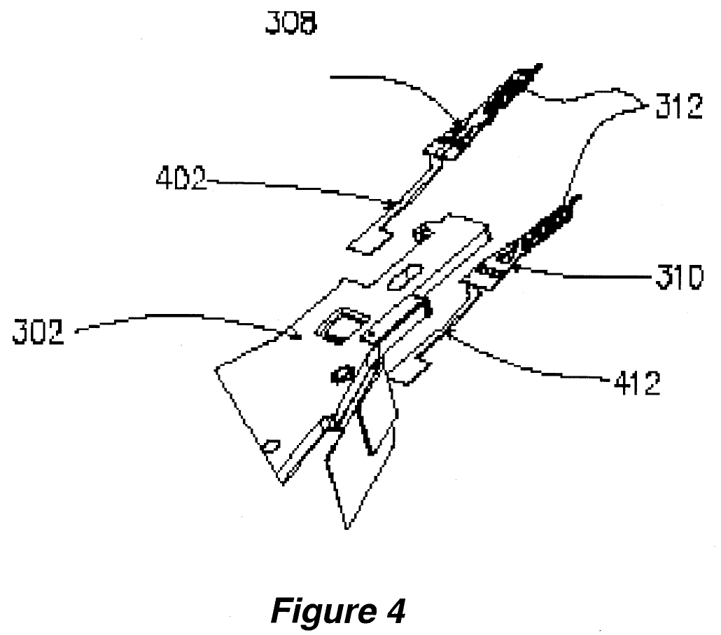

An expanded illustration of the first HGA 308 and the second HGA 310 is shown in FIG. 4. In one embodiment, the first HGA 308 and the second HGA 310 are coupled to the HGA 302 by laser welding. In a further embodiment, the first HGA 308 and the second HGA 310 are a loadbeam and flexible support assembly. In one embodiment, a first flexible printed circuit 402 is attached to the first HGA 308 and a second flexible printed circuit 404 is attached to the second HGA 310 to allow the hard drive control circuitry to communicate with the slider head 312 on each HGA.

Although several embodiments are specifically illustrated and described herein, it will be appreciated that modifications and variations of the present invention are covered by the above teachings and within the purview of the appended claims without departing from the spirit and intended scope of the invention.

1. A head stack assembly, comprising:
a head arm assembly;
a first head gimbal assembly (HGA) coupled to the head arm assembly, the first HGA supporting a first slider; and
a second HGA coupled to the head arm assembly, the second HGA supporting a second slider.

2. The head stack assembly of claim 1, further comprising:
a first flexible printed circuit assembly coupled to the first slider through the first HGA; and
a second flexible printed circuit assembly coupled to the second slider through the second HGA.

3. The head stack assembly of claim 1, wherein the first HGA and the second HGA both comprise:
a loadbeam assembly; and
a flexible support assembly.

4. The head stack assembly of claim 1, wherein the first HGA and the second HGA are coupled to the head arm assembly by laser welding.

5. The head stack assembly of claim 1, wherein the first HGA and the second HGA act as micro-actuators.

6. The head stack assembly of claim 1, wherein the head arm assembly is made of aluminum.

7. The head stack assembly of claim 1, wherein the head arm assembly is a unimount head arm assembly.

8. The head stack assembly of claim 1, wherein more than two HGAs are coupled to the head arm assembly.

9. A system, comprising:
a head arm assembly;
a first head gimbal assembly (HGA) coupled to the head arm assembly, the first HGA supporting a first slider;
a second HGA coupled to the head arm assembly, the second HGA supporting a second slider;
a voice coil motor to position the head arm assembly; and
a first storage disk to be read on a first side by the first slider of the first HGA assembly.

10. The system of claim 9, further comprising:
a first flexible printed circuit assembly coupled to the first slider through the first HGA; and
a second flexible printed circuit assembly coupled to the second slider through the second HGA.

11. The system of claim 9, wherein the first HGA and the second HGA both comprise:
a loadbeam assembly; and
a flexible support assembly.

12. The system of claim 9, wherein the first HGA and the second HGA are coupled to the head arm assembly by laser welding.

13. The system of claim 9, wherein the head arm assembly act as an actuator driving section.

14. The system of claim 9, wherein the head arm assembly is made of aluminum.

15. The system of claim 9, wherein the head arm assembly is a unimount head arm assembly.

16. The system of claim 9, wherein the second slider of the second HGA reads the first storage disk on a second side.

17. The system of claim 9, further comprising a second storage disk, wherein the second slider of the second HGA reads the second storage disk on a first side.

18. The system of claim 9, wherein more than two HGAs are coupled to the head arm assembly.

19. A method, comprising:
coupling a first HGA with a first slider to a head arm assembly; and
coupling a second HGA with a second slider to the head arm assembly.

20. The method of claim 19, further comprising:
connecting a first flexible printed circuit assembly to the first slider through the first HGA; and
connecting a second flexible printed circuit assembly to the second slider through the second HGA.

21. The method of claim 19, wherein the first HGA and the second HGA both comprise a loadbeam assembly and a flexible support assembly.

22. The method of claim 19, wherein the first HGA and the second HGA are coupled to the head gimbal assembly by laser welding.

23. The method of claim 19, wherein the head arm assembly act as an actuator driving section.

24. The method of claim 19, wherein the head arm assembly is made of aluminum.

25. The method of claim 19, wherein the head arm assembly is a unimount head arm assembly.

26. The method of claim 19, wherein more than two HGAs are coupled to the head arm assembly.
